(19) United States
(12) Patent Application Publication
(10) Pub. No.: US 2007/0100891 A1
(43) Pub. Date: May 3, 2007

(54) Method of forming a multimedia package

(76) Inventor: Patrick Nee, New York, NY (US)

Correspondence Address: WITHROW & TERRANOVA, P.L.L.C., 100 REGENCY FOREST DRIVE, SUITE 160, CARY, NC, 27518, US

(21) Appl. No.: 11/588,191

(22) Filed: Oct. 26, 2006

Related U.S. Application Data
(60) Provisional application No. 60/730,419, filed on Oct. 26, 2005.

(51) Int. Cl. G06F 17/00

(52) U.S. Cl. 707/104.1

(57) ABSTRACT

A method of forming a multimedia package is provided. The method obtains a media stream having media segments where the media segments include metadata associated with content in the media segments. The method indexes the media segments in accordance with the metadata. Furthermore, the method obtains preferred information and searches the indexed media segments for preferred information media segments where metadata of the preferred information media segments includes information corresponding to the preferred information. The method also forms the multimedia package with the preferred information media segments and delivers the multimedia package.

The present application claims priority from U.S. Provisional Patent Application Ser. No. 60/730,419 filed on Oct. 26, 2005. The content of the above-identified patent application is hereby incorporated by reference herein in its entirety.

### FIELD OF THE INVENTION

The present invention relates generally to media productions and more specifically to a method of forming a multimedia package.

### BACKGROUND

Typically, when a viewer watches a media broadcast, the viewer has no discretion over which portions of the media production the viewer may watch. Accordingly, if the viewer is only interested in a few segments of the media broadcast, the viewer may be forced to watch an entire media broadcast in order to catch the few portions which interest them. The viewer also may have to endure hours of programming in order to see the three or four minutes of the actual broadcast in which they are interested. This problem may be exacerbated if the viewer is interested in the content of multiple media broadcasts. As may be appreciated, this wastes the viewer's time.

Furthermore, a viewer may have an interest in a number of media broadcasts which are simultaneously broadcast. However, the viewer may only be able to watch a single media broadcast at one time. Therefore, the viewer may potentially miss portions of other media broadcasts which the viewer deems important.

Accordingly, a need exists for a method which classifies various portions of a media broadcast and allows quick retrieval of those portions. In addition, a need exists for a method which organizes the retrieved portions in a manner which is easily reviewable by a user.

### SUMMARY OF THE INVENTION

In accordance with a first aspect of the present invention, a method of forming a multimedia package is provided. The method comprises obtaining a media stream having media segments where the media segments include metadata associated with content in the media segments and indexing the media segments in accordance with the metadata. The method also includes obtaining preferred information and searching the indexed media segments for preferred information media segments. In accordance with embodiments of the present invention, metadata of the preferred information media segments includes information corresponding to the preferred information. The method also includes forming the multimedia package with the preferred information media segments and delivering the multimedia package.

In a further aspect of the present invention, a method of forming a multimedia package is provided. The method includes creating a content database and creating the multimedia package using the content database. The method creates the content database by obtaining a media stream having media segments where the media segments include metadata associated with content in the media segments and indexing the media segments in accordance with the metadata. The method creates the multimedia package by obtaining preferred information and searching the indexed media segments for preferred information media segments. In some embodiments, metadata of the preferred information media segments includes information corresponding to the preferred information. The operation of creating the multimedia package also includes forming the multimedia package with the preferred information media segments. After creating the multimedia package, the method delivers the multimedia package to a user.

In yet another embodiment of the present invention, a computer program product adapted to form a multimedia package is provided. In one embodiment, the computer program product comprises a medium readable by a computer having computer program code adapted to obtain a media stream having media segments where the media segments include metadata associated with content in the media segments. In addition, the computer program code is adapted to index the media segments in accordance with the metadata and obtain preferred information. The computer program code is also adapted to search the indexed media segments for preferred information media segments where metadata of the preferred information media segments includes information corresponding to the preferred information. Moreover, the computer program code is adapted to form the multimedia package with the preferred information media segments and deliver the multimedia package.

In a further embodiment of the present invention, a computer program product adapted to form a multimedia package is provided. The computer program product comprises a medium readable by a computer having computer program code. The computer program code is adapted to create a content database and create the multimedia package. The computer program code is also adapted to obtain a media stream having media segments where the media segments include metadata associated with content in the media segments and index the media segments in accordance with the metadata. Furthermore, the computer program code is adapted to obtain preferred information and search the indexed media segments for preferred information media segments where metadata of the preferred information media segments includes information corresponding to the preferred information. The computer program code is also adapted to form the multimedia package with the preferred information media segments and deliver the multimedia package.

Other features and advantages of the present invention will become more fully apparent from the following detailed description of the preferred embodiments, the appended claims, and the accompanying drawings.

### BRIEF DESCRIPTION OF THE DRAWINGS

FIG. 1 illustrates a method for forming a multimedia package in accordance with an embodiment of the present invention.

FIG. 2 illustrates a method which indexes media segments of a media broadcast to form a content database in accordance with an embodiment of the present invention.

FIG. 2A illustrates a content database in accordance with an embodiment of the present invention.

FIGS. 3A and 3B show a method for assembling a multimedia package in accordance with an embodiment of the present invention.

FIG. 4 illustrates a system of delivering a multimedia package to a user in accordance with an embodiment of the present invention.

FIG. 5 is a system which may be used to deliver a multimedia package to a user in accordance with a further embodiment of the present invention.

FIG. 6 is an embodiment of the present invention showing a system which may be used to deliver a multimedia package to a user.

FIG. 7 illustrates a system which may be used to deliver a multimedia package to a user in accordance with a further embodiment of the present invention.

### DETAILED DESCRIPTION

The present invention provides a method of receiving a media stream, such as a media broadcast, and forming a database of media segments within the media broadcast. The database is organized according to the metadata of the content within the media segments. In addition, the present invention provides a method forming a multimedia package which incorporates portions of the media segments from the database. As will be more clearly described with reference to the attached Figures, the present invention selects media segments from the database based on the preferences of a user who will use the multimedia package.

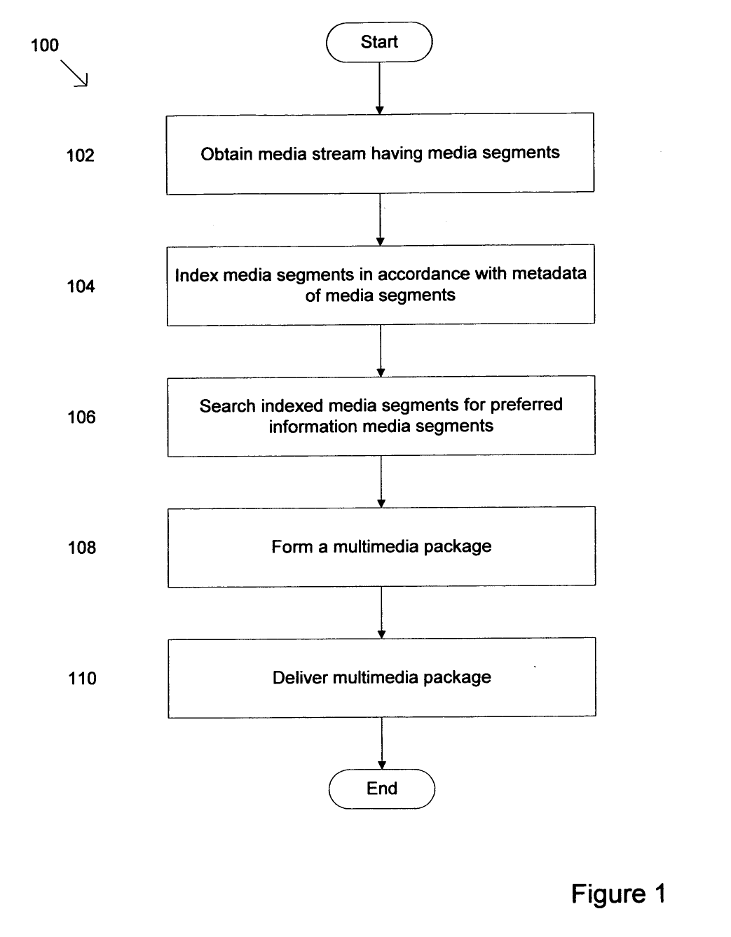

Now making reference to the Figures, FIG. 1 illustrates a method 100 for forming a multimedia package in accordance with an embodiment of the present invention. The method 100 may be used to form a multimedia package which may include both audio and video components. During an operation 102, the method 100 obtains a media stream having media segments such as a media broadcast having various media segments. An example of a media broadcast may be a sport broadcast such as a football game, a baseball game, a soccer game, a business news broadcast, or the like. Nevertheless, the media stream may be any type of information stream. An example of media segments within a sports broadcast includes individual plays which comprise the entire sporting event of the sports broadcast. An example of media segments within a business news broadcast include a telecast pertaining to individual topics of the day, such as the performance of separate stocks (i.e., GM, Yahoo, etc.), the performance within a particular industry (i.e., software, energy, finance, etc.) or the like.

It should be noted that a media segment within the media broadcast may include content that exists in another media segment. To further illustrate, in a sports broadcast of a football game, a passing play may comprise one media segment and an entire offensive drive which includes the passing play and a running play may be another media segment. In a business news broadcast, a media segment may discuss an industry (e.g., software industry) while another segment may discuss a company within the industry (e.g., Microsoft). In addition, portions of the media broadcast may not be included such as cheerleaders in a sporting event or commercials in a business news broadcast, or the like.

An example of selecting a source media stream may include selecting the previously mentioned sports broadcast or the business news broadcast. In accordance with some embodiments of the present invention, input media segments may be based on a number of input media streams. To further illustrate, the universe of source material for a particular output media stream may be segments from a plurality of source video streams. This may comprise media segments from all football broadcasts from a week's games where individually input media segments for that week's games may comprise the output multimedia package. In another example, input media segments may be segments from multiple business TV shows.

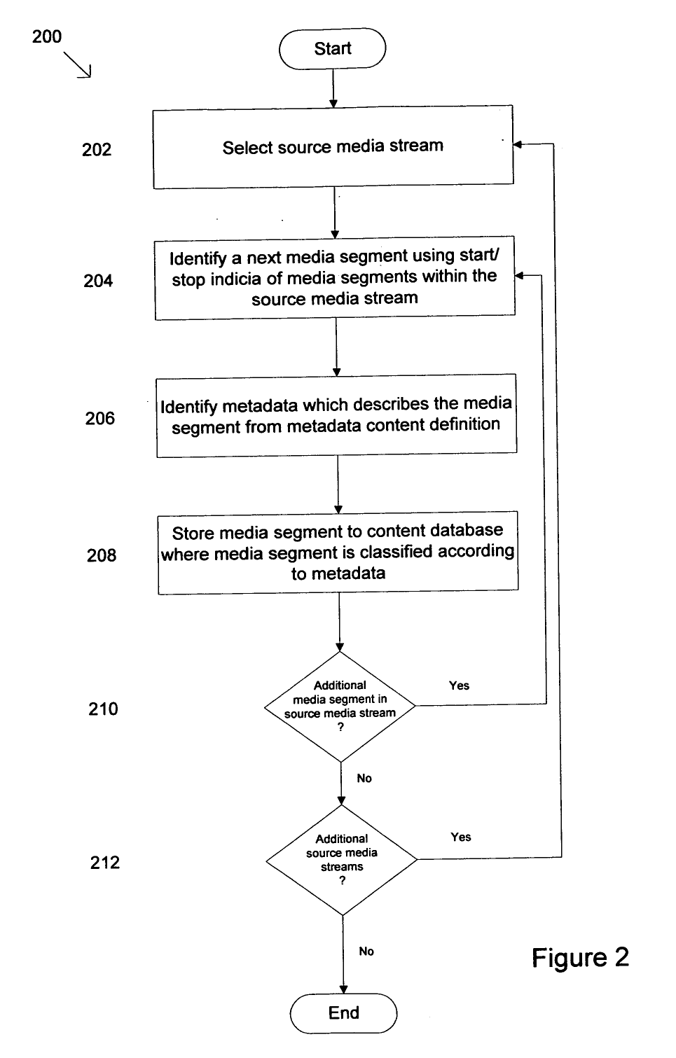

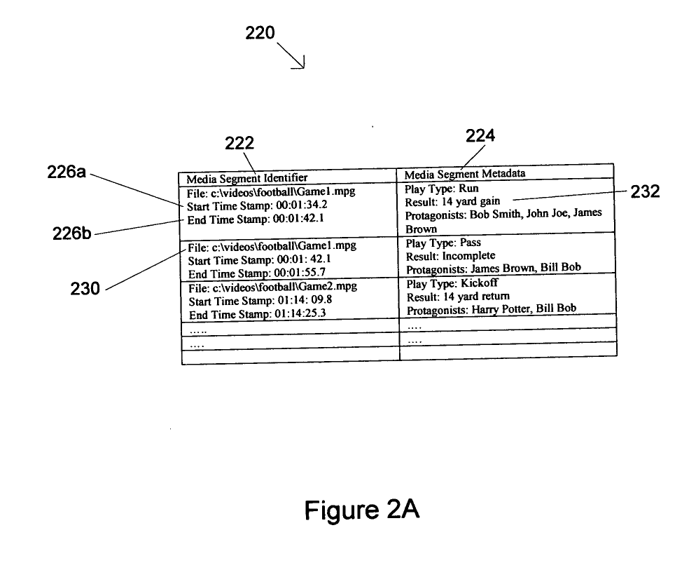

In one example, (hereinafter referred to as “our example”) during the operation 102, the method 100 obtains a media broadcast of a series of football games between a number of football teams. After completing the operation 102, the method 100 performs an operation 104. In this operation, the method 100 indexes media segments in accordance with metadata of the content of the media segments as typified by a method 200 shown with reference to FIG. 2.

FIG. 2 illustrates a method 200 which indexes media segments of a media broadcast in accordance with an embodiment of the present invention. Initially, the method 200 selects a source media stream in an operation 202. Returning back to our example, in the operation 202, the method 200 selects a media broadcast of a series of football games between a number of football teams as the source media stream. After the method 200 selects a source media stream in the operation 202, the method 200 performs an operation 204.

In the operation 204, the method 200 identifies a next media segment within the media broadcast using start/stop indicia of the media segments within the broadcast. In some embodiments, a plurality of indicia may be used for each segment. In addition, the type of indicia may differ from segment to segment. For example, in the sports broadcast example, start and stop times may be determined by referee actions (i.e., calling a dead play, calling a penalty, etc.), by identifying a change in the graphics overlay of the down counter on the media broadcast of the game, by identifying a commercial, or the like. In addition, the start/stop points of the media segments may be determined manually. To further illustrate, the source media broadcast may be recorded (i.e., digitally recorded) and reviewed by a user. The user may then determine the starting and ending indicia of media segments of the media broadcast.

Turning attention back to our example, the method 200 uses referee actions (i.e., setting the football at the line of scrimmage prior to starting a play) to determine a starting indicia of a media segment. In addition, in our example, the method 200 uses referee actions (i.e., calling a play dead) to determine an ending indicia of a media segment.

Upon completing the operation 204, the method 200 performs the operation 206 where the method 200 identifies metadata which describes the media segment from the metadata content definition. To further illustrate, metadata content of a football play segment in the media broadcast may include the type of play (i.e., offensive or defensive), the protagonist (i.e., linebacker, quarterback, running back, wide receiver, etc.), or any other type of information typically associated with the media segment. However, the metadata content may also include information regarding the football play segment such as time of possession, field position, and the like. Accordingly, the method 200 identifies the various types of metadata from the metadata content which describe the media segment.

Turning attention to our example, the method 200 identifies metadata such as the type of play and the protagonist involved in the play. The method 200 determines that this metadata, as opposed to time of possession, field position or the like, adequately describes the media segment. It should be noted that in accordance with alternative embodiments of the present invention, the method 200 may determine that the time of possession, field of position, or the like adequately describe the media segment.

In some embodiments of the present invention, the protagonist or other metadata may be identified by voice recognition analyzing the play-by-play announcements, or with video sports analysis systems such as StatShot™ from Pure Dynamics, of Wildon, Austria.

After the method 200 identifies metadata which describes the media segment, the method 200 completes an operation 208 where the media segments are stored to a content database and the media segment is classified according to the metadata of the content of the media segment. More specifically, the method 200 creates a database of media segments and their metadata. The segmentation may, in some embodiments, be into separate media files. In some embodiments, the media segments may be stored as entire files rather than subsets of the complete file. Alternatively, the source media stream may remain intact with the segmentation occurring by noting and storing the start and end indicia of the segment (for example, the start and end time code, or alternatively, the start and end frame in video media, or alternatively, the data positions in the file, or other such methods). In accordance with an embodiment of the present invention, video, audio, and graphic data which may constitute a media segment may be stored separate from the metadata and segment description data.

In some embodiments, a media segment may be stored in a file system while metadata and information indicating the location of the file (such as a file path) may be stored in a database such as a flat file or a relational database. In other embodiments, the media segment may be stored in a file representing the source media stream, and the metadata may include the file path to the source media stream and start and end indicia (such as start and end times, or start and end frames) for the media segment. In yet other embodiments, the media segment may be stored in the database along with the metadata. In an embodiment where the start/stop points are determined manually, the user would also manually catalog the content and store the content in the content database.

An example of a content database is more clearly shown with reference to FIG. 2A, which illustrates a content database 220 in accordance with an embodiment of the present invention. The content database 220 includes a media segment identifier 222 and media segment metadata 224. In some embodiments, the media segment identifier 222 includes start/stop indicia 226a and 226b of a media segment and a source stream identifier 230 of the media segment. Furthermore, the media segment metadata 224 includes content metadata 232 which describes some aspects the media segment.

Turning attention back to our example, the method 200 stores the football play to the content database. Moreover, the football play is indexed according to the protagonists (i.e., quarterback and running back) and the type of play (i.e., passing play and running play). After completing the operation 208, the method 200 performs an operation 210.

In the operation 210, the method 200 ascertains if there are additional media segments in the media source stream. If the source stream includes an additional media segment, the method 200 repeats the operation 204. Otherwise, the method 200 begins an operation 212 where the method 200 queries whether or not there are additional source media streams. If there are additional source media streams, the method 200 repeats the operation 202. However, if all relevant source media streams have been indexed and stored in the content database, the method 200 is complete. As described above, the method 200 may be automated. Those skilled in the art will recognize that there are numerous ways to automate the segmentation and indexing of a source media broadcast.

Turning back to our example, in the operation 210, the method 200 determines that there are no other media segments in the source media stream. Therefore, the operation 212 is performed where the method 200 determines that there are no additional source media streams.

Returning attention to FIG. 1 and the method 100, after the media segments are indexed in the operation 104, the method 100 begins an operation 106. In the operation 106, the method 100 obtains preferred information and the indexed media segments are searched for the preferred information media segments. The preferred media segments correspond to preferred information selected by a user. The preferred information relates to information desired by a user. More specifically, in an example of a sports broadcast, the preferred information may relate to a team of a user. The user may have a roster which includes a number of protagonists. Here, the preferred information relates to the protagonists on the roster of the team of the user and plays in which the protagonists were involved during a sports broadcast. Operation 106 is facilitated if the preferred information is represented by the same terms that appear in the metadata content definition, however, sophisticated programs, such as widely used search engines from Google and Yahoo, can perform the search of operation 106 even if the preferred information is expressed with other terms.

The preferred information may relate to actions by the protagonist (i.e., a quarterback on the user's roster passing the ball, a running back on the user's roster running the ball, etc.) or an action involving the protagonist (i.e., a defensive drive involving linebacker on the roster of the user, etc.). Where the user has a roster, the user may be interested in the performance of the protagonist listed on their roster (i.e., the total yards passing by the user's quarterback, the total yards rushing by the user's running back, the total number of tackles by the user's linebacker, etc.). Where the preferred information relates to fantasy football, a service (i.e., ESPN.com, Yahoo.com, etc.) may store a user's preferred information where a user may manually input their preferred information.

In an example of a business news broadcast, the preferred information may relate to a stock portfolio of a user or stocks that may be of interest to a user (i.e., competitor stocks, stocks a user is considering acquiring, stocks relating to a particular industry, etc.)

During the operation 106, the method 100 searches the indexed media segments stored in the content database for media segments having preferred information. In an embodiment where the preferred information corresponds to a protagonist on a team roster, the method 100 searches the content database for media segments which include information about the protagonist on the team roster (i.e., the method 100 searches the content database for passes which involve a quarterback who is on the fantasy football roster, defensive plays which involve a linebacker who is on the fantasy football roster, etc.).

Some fantasy football leagues determine the team standing by organizing head-to-head games between individual users each week where a user accumulates a win or a loss depending upon the outcome of his opponent that week. In an embodiment where a user is in a fantasy football league having the head-to-head organization, the preferred information for a user may be their fantasy football roster and the roster of the opposing team.

Furthermore, in some fantasy football leagues, users may change the players on their roster each week. More specifically, players may come off of a free agent list of the league, or the player may be traded for another player. In this situation, a user may wish to view the media segments in which potential acquisitions are protagonists. Therefore, the preferred information for a user may include players on the free agent list, players that are frequently traded as measured in other leagues, or other likely acquisitions.

In an embodiment where the media broadcast in a business news broadcast, the preferred information may pertain to protagonists (i.e., stocks) within the portfolio of a user. Here, the method 100 searches the content database for media segments which include information about a protagonist in a stock portfolio (i.e., any discussions made about the performance of a particular stock, any discussions about the performance within a particular industry, etc.). The method 100 searches the entire content database until all media segments having the preferred information are found.

Returning to our example, in the operation 106, a user determines that preferred information includes the protagonist (i.e., the quarterback and the running back) and the type of play (i.e., passing plays and running plays) in which the protagonist is involved. As such, after obtaining the preferred information, the method 100 searches the content database for media segments having the quarterback involved in passing plays and the running back involved in running plays.

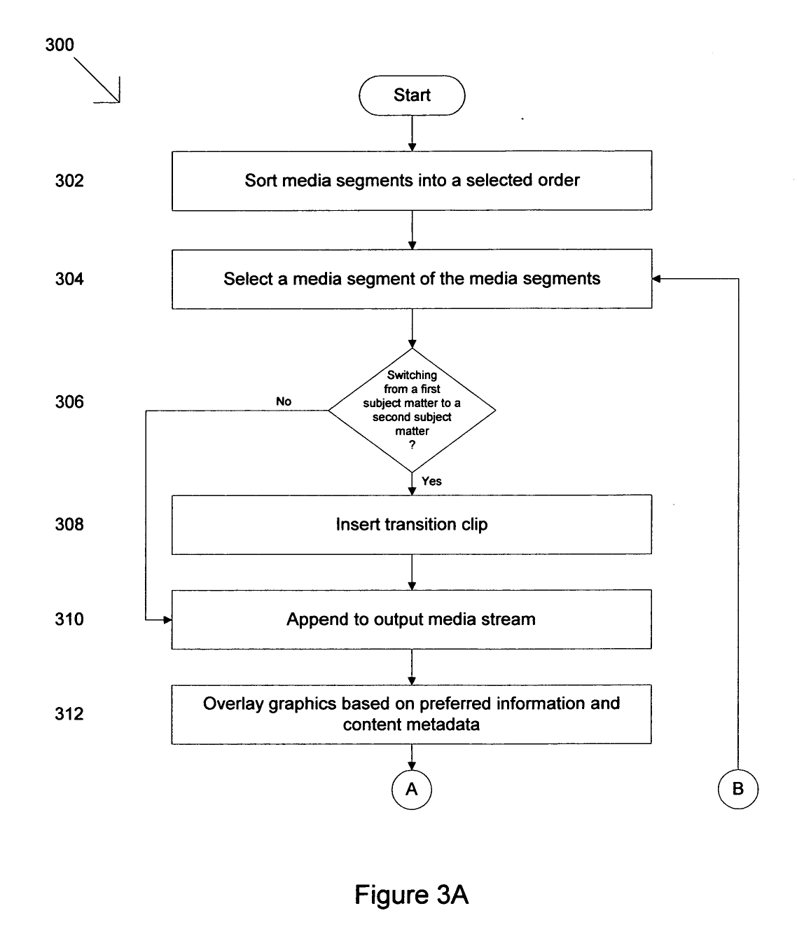

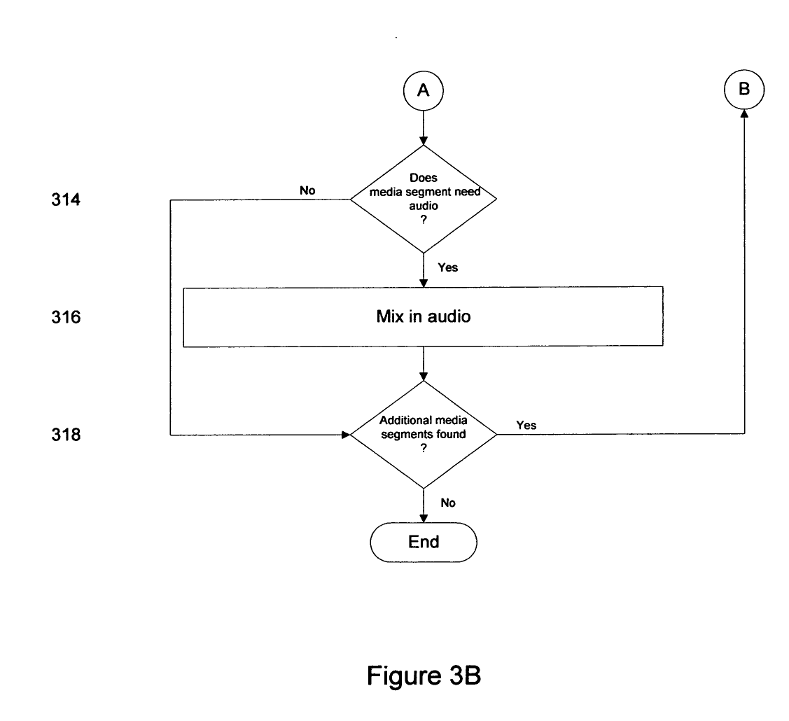

After the method searches the content database in the operation 106, the method 100 performs an operation 108 where the method 100 forms a multimedia package with the preferred information media segments as typified by a method 300 shown with reference to FIGS. 3A and 3B.

FIG. 3A illustrates the method 300 for assembling a multimedia package in accordance with an embodiment of the present invention where the multimedia package is formed with the present invention media segments. Initially, the method 300 performs an operation 302 where, after the media segments with content matching the preferred information have been found, the media segments are sorted into a selected order.

In accordance with an embodiment of the present invention, the media segments found in the content database during the operation 106 are sorted such that a first preferred information media segment precedes a second preferred information media segment and the second preferred information media segment precedes a third preferred information media segment, etc. In some embodiments, the preferred information media segments may be assembled according to the chronological order of events occurring in the preferred information media segments. In other embodiments, the segments may be randomly sorted. Alternatively, the segments may be grouped by protagonist, (i.e., showing all of the plays in which the quarterback was a protagonist, followed by the running back, etc.). In an embodiment where the preferred information media segments are grouped according to the protagonist, the preferred information media segments maybe sorted alphabetically according to the protagonist.

In a fantasy football league where two fantasy teams are competing head-to-head, in some embodiments, the preferred information media segments from each team may be alternated to heighten the competitive nature of the game. In other embodiments, all of the plays for one team may be assembled, followed by all of the plays of the opposing team.

It should be noted that in some embodiments, a single football play may appear numerous times in an output media stream, such as when a receiver and a quarterback are both protagonists in the play. Accordingly, a preferred information media segment may appear numerous times in a multimedia package.

Returning attention to our example, during the operation 302, the method 300 sorts the preferred information media segments into alphabetical order of the protagonists. Therefore, plays involving the quarterback are placed before plays involving the running back. After the preferred information media segments are sorted in the operation 302, the method 300 performs an operation 304.

During the operation 304, the method 300 selects a media segment of the preferred information media segments sorted in the operation 302. After selecting a preferred information media segment in the operation 304, the method 300 determines if the selected preferred information media segment needs a transition a clip in an operation 306. In accordance with an embodiment of the present invention, the preferred information selected media segment may need a transition clip when the subject matter of the selected preferred information media segment differs from the subject matter of the preferred information media segment which immediately precedes the selected preferred information media segment.

If the method 300 determines that the preferred information media segment does need a transition clip, the method performs an operation 308. Otherwise, if the preferred information media segment does not need a transition clip, an operation 310 is performed. In an embodiment where a preferred information media segment needs a transition clip, the transition clip may be an introduction for the next protagonist.

Returning to our example, as the first preferred information media segment shows a passing play involving a quarterback and the second preferred information media segment displays a running back, different from the quarterback, involved in a running play, a transition clip may be required. Thus, the method 300 inserts a transition clip between the first preferred information media segment and the second preferred information media segment in the operation 308. In our example, the transition clip may an introduction identifying the protagonist and summarizing the performance of the protagonist for that day.

After the method 300 inserts the transition clip during the operation 308, the method appends the preferred information media segment to an output media stream in the operation 310. Software tools for appending media streams are commonly available, such as the DirectX toolset from Microsoft, Inc, of Redmond, Wash. After the preferred information media segment has been appended to the output media stream in the operation 310, the method 300 begins an operation 312.

During the operation 312, the method 300 overlays graphics based on the preferred information and content metadata on the preferred information media segment. In some embodiments, a user may desire graphics in addition to the graphics provided during the preferred information media segment. Therefore, in some embodiments, graphics customized for the user may be overlaid on the preferred information media segments.

For example, in a preferred information media segment showing a protagonist on the fantasy league roster of the user, the name of the protagonist may be overlaid onto the preferred information media segment along with the amount of points the protagonist contributed to the fantasy team during that particular week. Similarly, the name of the fantasy team may be overlaid on to the preferred information media segment. In other embodiments, a “virtual score,” which may represent the points accumulated by the players on the fantasy team of a user which may be already shown in the output media stream may be overlaid on the preferred information media segment, thereby enhancing the simulation of a real game.

In an embodiment where the preferred information media segments relate to a business news broadcast, a news report discussing a particular stock in the portfolio of a user may have a overlaid graphic which may include the ticker symbol of the stock, the percentage the particular stock represents in the portfolio of the user, or the percentage change in value of the stock for the particular stock or any other pertinent information. In accordance with an embodiment of the present invention, the graphics may be overlaid onto the media segments using any suitable techniques, such as bitmap overlays or other techniques available through tools such as DirectX from Microsoft, Inc., of Redmond, Wash., or the like. Returning attention to our example, in the operation 312, graphics are overlaid on the present invention media segments involving the quarterback and the running back. In the preferred information media segment showing the quarterback, the quarterback's statistics for that day (i.e., attempts, completions, touchdowns, interceptions, etc.) are overlaid onto the preferred information media segment. Moreover, in the preferred information media segment showing the running back, the statistics (i.e., number of carries, yardage gained, receptions, receiving yards, etc.) of the running back are overlaid onto the preferred information media segment. It should be noted that the graphics are generated based on the preferred information and the metadata in the present invention media segment. After graphics are overlaid onto the preferred information media segment in the operation 312, the method 300 performs an operation 314, as shown with reference to FIG. 3B.

In the operation 314, the method 300 determines if the preferred information media segment needs audio. If the preferred information media segment needs audio, the method 300 begins an operation 316 where audio is mixed with the preferred information media segment. Otherwise, the method 300 performs an operation 318.

In some embodiments, an audio track of the output media stream (i.e., multimedia package) may be the same as the audio track (or tracks) for the source audio stream. In other embodiments, the audio track of the output media stream (i.e., multimedia package) is a subset of the tracks of the source media stream (i.e., media broadcast). For example, the output media stream may include crowd noise of the football game and not the play-by-play announcers for media segments pertaining to a sports broadcast. It should be noted that in addition to mixing audio with the preferred information media segments during the operation 314, audio segments may also be mixed with the media segments during the method 200 when media segments of a media broadcast are indexed.

In some embodiments, the audio track may be recorded for a media segment or set of segments and included in the output stream. To further illustrate, an audio stream commenting on the performance of a protagonist may be recorded and mixed over a set of multiple plays in which the protagonist appears.

In some embodiments, sets of stock phrases may be created and combined with metadata of the media segment. To further illustrate, if the metadata for a particular segment reflects the performance of a protagonist such as “the quarterback passed for 215 yards,” the stock recording of the “quarterback, “passed,” and “215 yards” may be combined to dynamically generate an audio commentary. In some embodiments, this audio track may be recorded by an actor. In other embodiments, this audio segment may be synthesized by text-to-voice technologies well known in the art. Additionally, audio for contiguous media segments may be mixed with techniques such as cross fading or other techniques well known to those skilled in the art. In some of these examples, the final audio may be supplied in a separate media stream and mixed in the preparation process or the production process.

Turning back to our example, the method 300 determines in the operation 314 that the preferred information media segments of both the quarterback and the running back need audio. Thus, the method 316 mixes audio with the preferred information media segments in the operation 316. It should be noted that the audio is generated based on the preferred information and the metadata. In our example, the method 300 mixes in the crowd noise from the football game along with the commentary from the play-by-play announcers at the football game.

After the method 300 mixes audio with the preferred information media segment, the method 300 looks for additional preferred information media segments in the operation 318. If the method 300 finds additional preferred information media segments, the method 300 repeats the operation 304. If the method 300 does not find additional preferred information media segments, the multimedia package is formed. Turning back to our example, the method 300 does not find additional preferred information media segments in the operation 318.

Returning attention to FIG. 1, after the multimedia package is formed in the operation 108, the method 100 performs an operation 110. In the operation 110, the method 100 delivers the multimedia package to an end user. In accordance with an embodiment of the present invention, the multimedia package may be stored on removable media (i,.e., CD-ROM, DVD or the like) for delivery to the user. This may be particularly useful in situations where rapid delivery is not critical, such as end-of-season highlights. In addition, the multimedia package may be a contiguous media stream.

In other embodiments, the multimedia package may be streamed (i.e., delivered substantially simultaneously with the viewing of the output media stream) over a network, such as the Internet such that the multimedia package may be viewed immediately.

In other embodiments, the multimedia package is delivered over a network to a persistent storage device, such a personal computer, an “mp3 player” (such as an ipod), a cellular telephone, a digital video recorder, or the like.

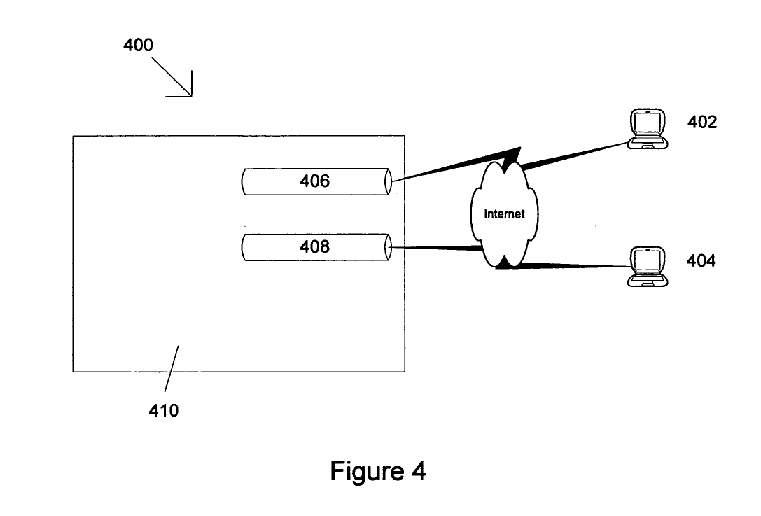

In other embodiments, the multimedia package may be delivered over a network using a variety of methodologies, as more clearly illustrated with reference to FIGS. 4-7. FIG. 4 illustrates a system 400 which delivers a multimedia package in accordance with an embodiment of the present invention. The system 400 includes a central server 410 and devices 402 and 404 communicatively coupled (i.e., through the internet) with the central server 410. In one embodiment of the present invention, the devices 402 and 404 may be persistent storage devices similar to those previously described above. Here, the central server 410 creates multimedia packages 406 and 408 using the methods described with reference to FIG. 1-3. In accordance with an embodiment of the present invention, the central server 410 includes the necessary hardware and software to create the multimedia packages 406 and 408. As such, a content database having indexed media segments and the multimedia packages 406 and 408 are created locally relative to the central server 410. Once the multimedia packages 406 and 408 are created at the central server 410, users at the devices 402 and 404 may access the multimedia packages over the internet directly from the central server 410 such that the multimedia packages 406 and 408 are respectively delivered to the devices 402 and 404.

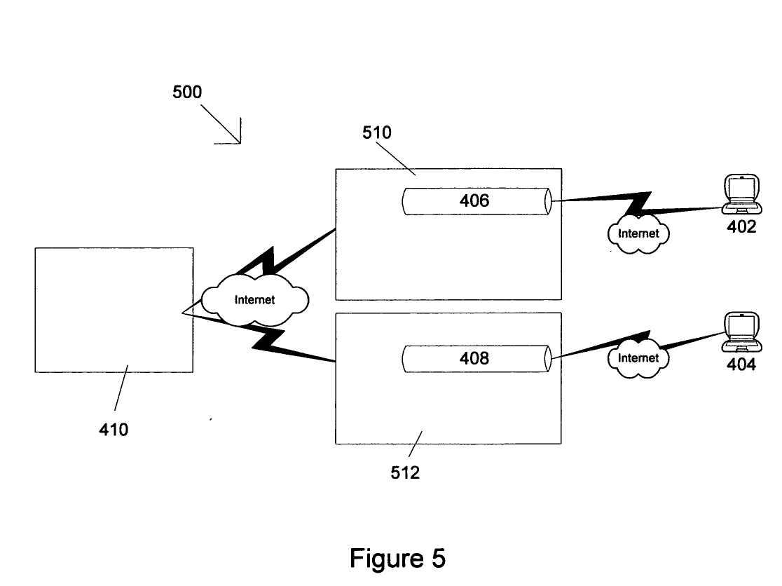

FIG. 5 illustrates a system 500 which may be used to deliver a multimedia package to a user in accordance with a further embodiment of the present invention. In this embodiment, the system 500 includes the central server 410 and peripheral servers 510 and 512 communicatively coupled (i.e., through the internet) with the central server 410. As may be seen with respect to the Figure, the device 402 communicatively couples (i.e., through the internet) with the peripheral server 510 and the device 404 communicatively couples (i.e., through the internet) with the peripheral server 512.

Here, the multimedia packages 406 and 408 have been delivered to the peripheral servers 510 and 512. In this embodiment, the central server 410 pushes the multimedia package 406 to the peripheral server 510 which is semi-local to the device 402. Moreover, the central server 410 pushes the multimedia package 408 to the peripheral server 510 which is semi-local to the device 406. The peripheral server 510 is closer to the device 402 than the central server 410 in the system 500. Additionally, the peripheral server 512 is closer to the device 406 than the central server 410 in the system 500.

The central server predicts which peripheral server 510 or 512 is more semi-local (closer) to device 402 by examining a history of device 402 or a history of the user. For example, if the IP address of device 402 is generally from a particular Internet Service Provider (ISP) semi-local to 510, the central server may predict that the next request for delivery will also come from this location and may deliver the media package to 510.

In this embodiment, the central server 410 creates the multimedia packages 406 and 408 immediately following the media broadcast using the methods discussed above with regards to FIGS. 1-3. After creation, the multimedia packages 406 and 408 are delivered to the peripheral servers 510 and 512, respectively, using any suitable technique, such as EdgeSuite Delivery available from Akamai Technology located in Cambridge, Mass. In this embodiment, the multimedia packages 406 and 408 are delivered to the peripheral servers 510 and 512 at periods when there is low network activity (i.e., during early morning hours) thereby efficiently using network bandwidth.

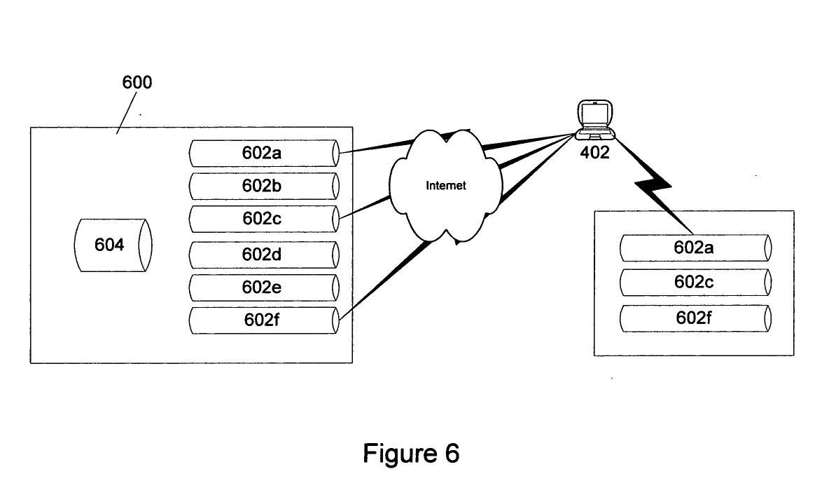

Alternatively, the multimedia package may be created locally at the device 402, as shown with reference to FIG. 6. In this embodiment, a central server 600 creates a content database 604 in a manner similar to that discussed with reference to FIG. 2 and the method 200 where the content database 604 includes various media segments 602a-602f. Thus, the content database is stored locally relative to the central server 600.

When a user at the device 402 desires to download a multimedia package, the device 402, which is communicatively coupled with the central server (i.e., through the internet), accesses the content database 604 at the central server 600 for media segments which correspond to the preferred information of the user. For example, the user may input the preferred information into the device 402 or the device 402 may automatically retrieve the preferred information from a database (i.e., Yahoo.com, etc.). Once the device 402 retrieves the preferred information, the device 402 searches the content database 604 for preferred information media segments. In this example, media segments 602a, 602c, and 602f include the preferred information. Therefore, the device 402 downloads the media segments 602a, 602c, and 602f. After the device 402 accesses and downloads the media segments 602a, 602c, and 602f, the device 402 creates a multimedia package in a manner similar to that discussed with FIGS. 1 and 3 and the method 300. Accordingly, the multimedia package is created at a location which is remote from the content database.

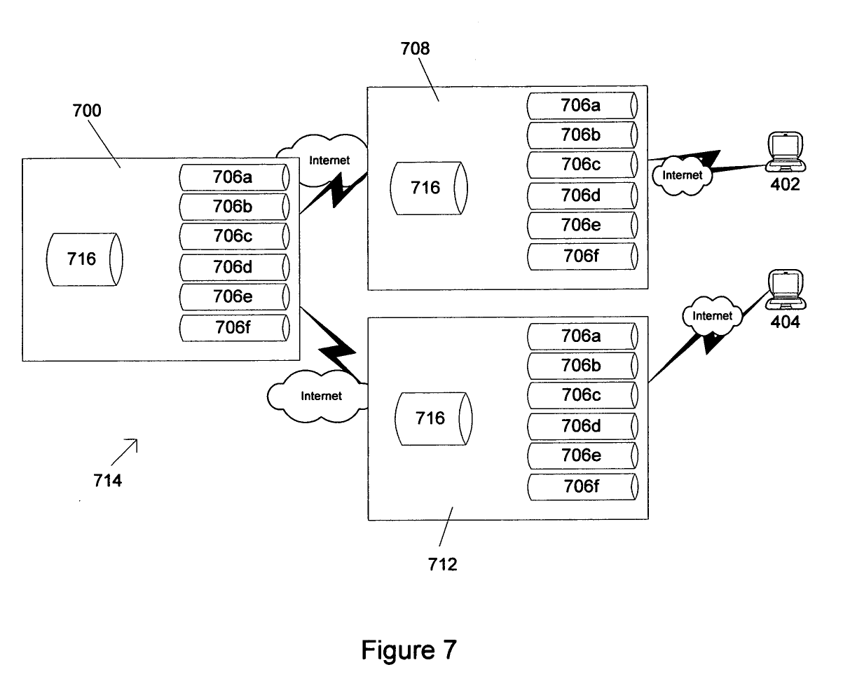

In addition to the system and method described with reference to FIG. 6, a multimedia package may be delivered to a user using a methodology described with reference to FIG. 7. FIG. 7 illustrates a system 714 which includes a central server 700 and peripheral servers 708 and 712 communicatively coupled with the central server 700 (i.e., via the internet). In this embodiment, the peripheral server 708 is semi-local to the device 402 and the peripheral server 712 is semi-local to the device 404 where the devices 402 and 404 communicatively couple (i.e., via the internet) with the peripheral servers 708 and 712, respectively.

The central server 700 creates a content database 716 after receiving a media broadcast in manner similar to that discussed with reference to FIG. 2 and the method 200. After the central server 700 creates the content database 716, the content database 716 is delivered to the peripheral servers 708 and 712. It should be noted that in some embodiments, only data which requires high bandwidth may be distributed to the peripheral servers 708 and 712. In some of these embodiments, the content database may not be copied to the peripheral servers 708 and 712, which instead query the content database on 700 remotely.

In this embodiment, when a user at the device 402 requests a multimedia package, the request is redirected to a peripheral server determined to be closest to the device 402 using any well known technique, such as HTTP redirect as defined by the World Wide Web Consortium standards available at http://www.w3.org/protocols/rfc2616/rfc2616-sec10.html#sec10.3, or the redirecting techniques used in the EdgeSuite Delivery of Akamai Technologies of Cambridge, Mass., or the like. In the system 714, the peripheral server 708 is closest to the device 402. Accordingly, the peripheral server 708 receives the request from the device 402. Upon receiving the request, the peripheral server 708 creates a multimedia package from the content database 716 and media segments 706a-706f stored thereon in accordance with method 300 described with respect to FIG. 3. Once the peripheral server 708 creates a multimedia package, the multimedia package is delivered to the device 402 and the user.

Similarly, if a user at the device 404 requests a multimedia package, the request is routed to the peripheral server 712 which is determined to be closest to the device 404. After receiving the request, the peripheral server 712 creates a multimedia package as described above and delivers the same to the device 404 and the user. This embodiment utilizes total bandwidth in a more efficient manner and improves response times because concurrent requests for multimedia packages are not concentrated at a central server, such as the central server 700.

In a further embodiment, the devices 402 and 404 may include software which enables creating a multimedia package as described with reference to FIG. 3 and the method 300. In this embodiment, the devices 402 and 404 may query the content database 716 to identify which of the media segments 706a-706f include the preferred information of the user. The devices 402 and 404 may then download these media segments locally. When the devices 402 and 404 receive the media segments which include the preferred information, the devices 402 and 404 may create the multimedia package in a manner similar to that discussed above.

To further illustrate, in an embodiment where the device 402 is a digital video recorder (DVR), the DVR may include a software application which gathers a user's fantasy team roster (i.e., from Yahoo.com). After gathering the fantasy team roster, the device 402 communicates the player roster to the content database 716 on the peripheral server 708. The preferred information media segments' indica corresponding to the fantasy team roster are sent to the device 402.

In some embodiments where the device 402 is a DVR, the device 402 captures the media streams by recording the original broadcasts or re-broadcasts of the content. In other embodiments where the device 402 is a DVR, the device 402 captures the preferred information media segments by recording only those segments during a re-broadcast of the content.

Upon receiving this information, the device 402 downloads the preferred information media segments (or alternatively the source media streams) locally, and locally assembles the multimedia package.

In at least one embodiment of the invention, the methods of FIGS. 1-3 are implemented in hardware employing a suitable combination of conventional logic circuitry such as adders, comparators, selectors, etc. Such hardware, for example, may be located within the servers 410, 510, 512, 600, 700, 708, and 712 and the devices 402 and 404. A person of ordinary skill in the art may develop logic circuitry capable of performing the inventive processes described with reference to FIGS. 1-3. In a software embodiment of the invention, the methods of FIGS. 1-3 may comprise one or more computer program products. Each inventive computer program product may be carried by a medium readable by a computer (e.g., a carrier wave signal, a floppy disk, a hard drive, a random access memory, etc.). It should be noted that a plurality of computer-based devices may be substituted with a single computer-based device. Accordingly, the various functionality that is described as being possessed by more than one device or article may alternatively be possessed by a single device or article.

Further, although operations, algorithms or the like may be described in a sequential order, such operations may be configured to work in different orders. In other words, any sequence or order of operations that may be explicitly described does not necessarily indicate a requirement that the operations be performed in that order. The operations described herein may be performed in any order practical. Further, some operations may be performed simultaneously despite being described or implied as occurring non-simultaneously (e.g., because one operation is described after the other operation). Moreover, the illustration of an operation by its depiction in a drawing does not imply that the illustrated operation is exclusive of other variations and modifications thereto, does not imply that the illustrated operation or any of its steps are necessary to the invention, and does not imply that the illustrated operation is preferred.

It will be readily apparent that the various methods and algorithms described herein may be implemented by appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (i.e., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices.

The term “computer-readable medium” refers to any medium that participates in providing data (i.e., instructions) that may be read by a computer, a processor or a like device. Such a medium may take many forms, including but not limited to, non-volatile media, volatile media, and transmission media. Non-volatile media may include, for example, optical or magnetic disks and other persistent memory. Volatile media may include DRAM, which typically constitutes the main memory. Transmission media may include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media may include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, i.e., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention may be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

As may be appreciated, the present invention provides a method of forming a multimedia package which avoids the problems associated with the prior art. More specifically, the present invention allows a user to view portions of media broadcasts that the user desires. In accordance with the present invention, the user does not have to view hours of media broadcasting. Moreover, in situations where media broadcasts occur simultaneously, the viewer does not run the risk of missing portions of a media broadcast.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed is:

1. A method of forming a multimedia package comprising:
obtaining a media stream having media segments where the media segments include metadata associated with content in the media segments;
indexing the media segments in accordance with the metadata;
obtaining preferred information;
searching the indexed media segments for preferred information media segments where metadata of the preferred information media segments includes information corresponding to the preferred information;
forming the multimedia package with the preferred information media segments; and
delivering the multimedia package.

2. The method as recited in claim 1, wherein the operation of indexing the media segments further comprises:
identifying metadata related to the media segments.

3. The method as recited in claim 2, wherein the operation of indexing the media segments further comprises:
identifying a start indicia and a stop indicia of the media segments.

4. The method of claim 1, wherein the operation of indexing the media segments further comprises:
storing the media segments as entire files rather than subsets of the complete file.

5. The method as recited in claim 1, wherein the operation of sorting the preferred information further comprises:
sorting the preferred information media segments in chronological order.

6. The method as recited in claim 1, wherein the operation of sorting the preferred information further comprises:
sorting the preferred information media segments according to preferred information in the media segments.

7. The method as recited in claim 1, wherein the operation of transmitting the multimedia package further comprises:
delivering the multimedia package to a persistent storage device.

8. The method as recited in claim 7, wherein the persistent storage device is a personal computer.

9. The method as recited in claim 7, wherein the persistent storage device is a mp3 player.

10. The method as recited in claim 7, wherein the persistent storage device is a cellular telephone.

11. The method as recited in claim 1, wherein the multimedia package is a contiguous media stream.

12. The method as recited in claim 1, wherein the operation of transmitting the multimedia package further comprises:
delivering the multimedia package for substantially immediate viewing.

13. The method as recited in claim 1, further comprising:
mixing audio generated based on the preferred information and the meta data with the preferred information media segments of the multimedia package.

14. The method as recited in claim 1, further comprising:
overlaying graphics generated based on the preferred information and the meta data on the preferred information media segments of the multimedia package.

15. The method as recited in claim 1, wherein the indexed media are stored at a first location.

16. The method as recited in claim 15, wherein the indexed media is searched from a location remote from the first location.

17. The method as recited in claim 16, wherein the multimedia package is formed at the location which is remote from the first location.

18. The method as recited in claim 1, wherein the media segments are stored and the multimedia package is formed at a location which is remote from the location where the media segments were indexed.

19. A method of forming a multimedia package comprising:
creating a content database, wherein the operation of creating the content database comprises:
obtaining a media stream having media segments where the media segments include metadata associated with content in the media segments; and
indexing the media segments in accordance with the metadata, thereby creating the content database;
creating the multimedia package using the content database, wherein the operation of creating the multimedia package comprises:
obtaining preferred information;
searching the indexed media segments for preferred information media segments where metadata of the preferred information media segments includes information corresponding to the preferred information; and
forming the multimedia package with the preferred information media segments;
delivering the multimedia package.

20. The method as recited in claim 19, wherein the operation of indexing the media segments further comprises:
identifying metadata related to the media segments; and
identifying a start indicia and a stop indica of the media segments.

21. The method of claim 19, wherein the operation of indexing the media segments further comprises:
storing the media segments as entire files rather than subsets of the complete file.

22. The method as recited in claim 19, wherein the operation of transmitting the multimedia package further comprises:
transmitting the multimedia package to a storage device.

23. The method as recited in claim 19, wherein the operation of transmitting the multimedia package further comprises:
transmitting the multimedia package for substantially immediate viewing.

24. The method as recited in claim 19, wherein the multimedia package is a contiguous media stream.

25. The method as recited in claim 19, further comprising:
mixing audio generated based on the preferred information and the metadata with the preferred information media segments of the multimedia package.

26. The method as recited in claim 19, further comprising:
overlaying graphics generated based on the preferred information and the metadata on the preferred information media segments of the multimedia package.

27. The method as recited in claim 19, wherein the content database is stored at a first location.

28. The method as recited in claim 27, wherein the content database is searched from a location remote from the first location.

29. The method as recited in claim 28, wherein the multimedia package is formed at the location which is remote from the first location.

30. A computer program product adapted to form a multimedia package, the computer program product comprising:
a medium readable by a computer, the computer readable medium having computer program code adapted to:
obtain a media stream having media segments where the media segments include metadata associated with content in the media segments;
index the media segments in accordance with the metadata;
obtain preferred information;
search the indexed media segments for preferred information media segments where metadata of the preferred information media segments includes information corresponding to the preferred information;
form the multimedia package with the preferred information media segments; and
deliver the multimedia package.

31. A computer program product adapted to form a multimedia package, the computer program product comprising:
a medium readable by a computer, the computer readable medium having computer program code adapted to:
create a content database, wherein the computer program code is adapted to:
obtain a media stream having media segments where the media segments include metadata associated with content in the media segments; and
index the media segments in accordance with the metadata, thereby creating the content database;
create the multimedia package, wherein the computer program code is adapted to:
obtain preferred information;
search the indexed media segments for preferred information media segments where metadata of the preferred information media segments includes information corresponding to the preferred information; and
form the multimedia package with the preferred information media segments;
deliver the multimedia package.
